(19) United States
(12) Patent Application Publication
(10) Pub. No.: US 2003/0208576 A1
(43) Pub. Date: Nov. 6, 2003

(54) System and method for conducting multiple communications with a party

(76) Inventors: A.C. McQuaide JR., Berkeley Lake, GA (US); David Scott, Norcross, GA (US); Xiaofeng Gao, Alpharetta, GA (US)

Correspondence Address: SHAW PITTMAN, IP GROUP, 1650 TYSONS BOULEVARD, SUITE 1300, MCLEAN, VA, 22102, US

(21) Appl. No.: 10/108,348

(22) Filed: Mar. 29, 2002

(51) Int. Cl. G06F 15/16; G06F 15/173

(52) U.S. Cl. 709/223; 709/227

(57) ABSTRACT

A system and method for permitting a subscriber to communicate with a caller using multiple forms of communication is disclosed. A service provider facilitates this communication by collecting and managing information related to both of the parties. A subscriber in communication with a caller can contact the service provider and request communications with the caller using a different form of communication. The service provider can respond to the request if the caller has the capabilities to conduct those communications.

### BACKGROUND

1. Field of the Invention

The present invention relates to a communications system, and more particularly, to a communications system configured to permit a subscriber to communicate with a caller using multiple forms of communication.

2. Background of the Invention

Most companies have provisions for dealing with customer contacts including inquiries, requests and complaints. Due to the high volume of customer contacts and the high cost of managing and responding to all of the customer contacts, some companies have resorted to automated interactive voice response (IVR) systems that interact with customers who call them. Through the use of various voice prompts, an automated IVR system receives information from customers and attempts to manage the customer contacts to satisfy the varying needs of the calling customers.

After interacting with the IVR system, customers who call are often placed “on hold” and told to wait until a customer service representative is available. Most customers find excessively long wait times inconvenient and unacceptable. These delays generate negative complaints by customers. If the delays persist, companies can develop reputations for poor customer service.

In addition to IVR systems plagued with long delays, some IVR systems can be quite complex, presenting a wide range of options that may be confusing and frustrating to certain customers.

There is a current need for companies to improve their responsiveness to customers and to provide more helpful information.

### SUMMARY OF THE INVENTION

In one aspect, the present invention is directed to a communications system that includes a service provider capable of receiving registration information from a subscriber and a caller. The service provider is configured to receive a first message from the subscriber, the first message including information related to the caller. The service provider then searches a database in response to the first message and sends a second message back to the subscriber. The second message contains information related to the caller. The service provider is also configured to receive a third message from the subscriber, the third message including information related to the subscriber, and to send a fourth message to the caller in response to the third message.

In another aspect, the second message includes information related to the caller's registration information.

In another aspect, the fourth message includes information related to a web site associated with the subscriber.

In another aspect, the service provider is configured to receive the third message from an IVR associated with the subscriber.

In another aspect, the first message includes a phone number of the caller.

In another aspect, the invention includes a service provider comprising a means for receiving registration information from a subscriber, a means for receiving registration information from a caller, a means for receive a first message from the subscriber, a means for searching a database in response to the first message, a means for sending a second message back to the subscriber, a means for receiving a third message from the subscriber, and a means for sending a fourth message to the caller in response to the third message.

In another aspect, wherein the second message includes information related to the caller's registration information.

In another aspect, wherein the fourth message includes information related to a web site associated with the subscriber.

In another aspect, service provider comprises a means for receiving the third message from an IVR associated with the subscriber.

In another aspect, the service provider comprises at least one of means for sending a proprietary message to a subscriber and means for receiving a proprietary message from a subscriber.

In another aspect, the invention includes a method for conducting multiple communications comprising the steps of registering with a service provider, receiving a call from a caller using a first form of communication, sending a first item of information related to the caller to a service provider, receiving, from the service provider, a second item of information related to the caller, the second item of information including information regarding the caller's registration for a service; and sending a third item of information to the service provider, the third item of information including information related to a subscriber.

In another aspect, the first form of communication is a telephone call.

In another aspect, an IVR receives the call from the caller.

In another aspect, wherein an IVR sends the first item of information to the service provider.

In another aspect, wherein the first item of information includes the caller's telephone number.

In another aspect, wherein the second item of information includes the caller's telephone number.

In another aspect, the third item of information includes a URL associated with the subscriber.

In another aspect, the third item of information includes information destined for the caller, which may be a URL associated with the subscriber.

Additional features and advantages of the invention will be set forth in the description which follows, and in part will be apparent from the description, or may be learned by practice of the invention. The objectives and advantages of the invention will be realized and attained by the structure and steps particularly pointed out in the written description, the claims and the drawings.

### BRIEF DESCRIPTION OF THE DRAWINGS

FIG. 1 is a schematic diagram of a communications system where a preferred embodiment of the present invention can be used.

FIG. 2 is a flow diagram of a preferred embodiment of a method in accordance with the present invention.

FIG. 3 is an enlarged schematic diagram of a communications system where a preferred embodiment of the present invention can be used.

### DETAILED DESCRIPTION OF THE INVENTION

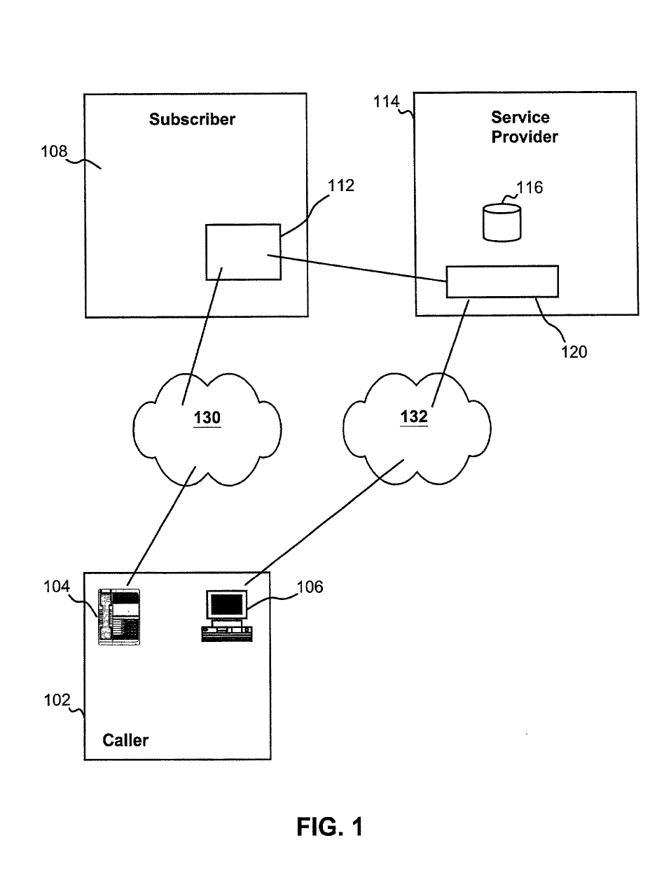

FIG. 1 is a schematic diagram of various systems in communication with a communications network. In a preferred embodiment, caller 102 is able to interact with subscriber 108 using different forms of communication. Preferably, caller 102 is able to communicate with subscriber 108 using telephonic communications and using a data network, for example, the Internet.

Service provider 114 is able to interact with subscriber 108 using a data network. Also, service provider 114 is able to interact with caller 102 using a data network, for example, the Internet.

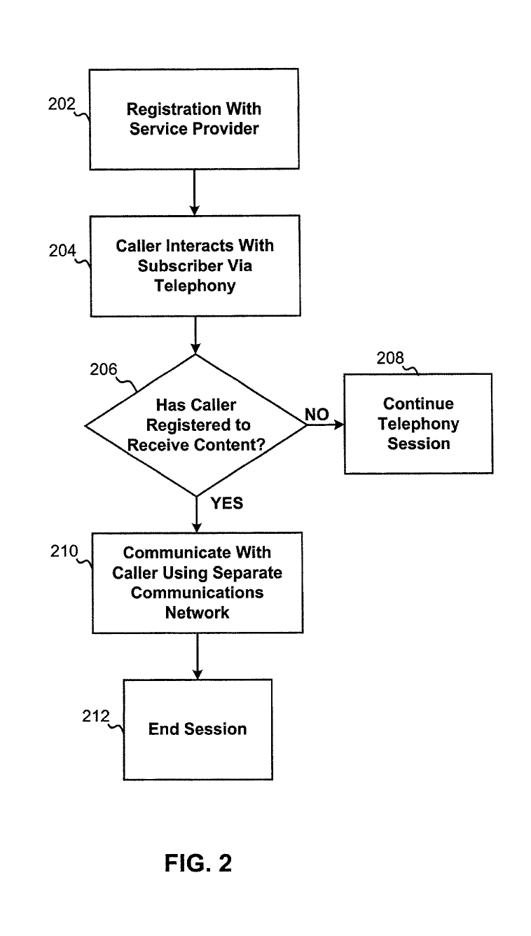

The operation and interaction of the various systems will be disclosed in connection with a preferred method. FIG. 2 is a flow diagram of a preferred embodiment of a method in accordance with the present invention.

Referring to FIGS. 1 and 2, in step 202, a caller 102 registers with service provider 114. Service provider 114 can be comprised of different forms of computer resources. For example, service provider 114 can reside on a computer and use portions of the computer, or service provider 114 can also be a computer or more than one computer in communication with one another.

Caller 102 registers with service provider 114 by providing a telephone number associated with a telephone 104 that is also associated with caller 102 and by informing service provider 114 that caller 102 is associated with a computer 106 that is capable of communicating with a data network, for example, the Internet 132, and providing the data network address of that computer. In some embodiments, computer 106 uses a high-speed connection, for example a Digital Subscriber Line (DSL), to communicate with data network 132. As shown in FIG. 1, service provider can use a connection agent 120 to manage communications to and from computer 106. Preferably, caller 102 registers with service provider 114 using an online registration process. In this way, service provider can determine the IP address of caller 102's computer 106. Preferably, software residing on computer 106 includes provisions that periodically and automatically update service provider 114 with the current registration information associated with computer 106. This is done because IP addresses can sometimes change, and it is desirable for service provider 114 have the current IP address of computer 106.

Service provider 114 collects and stores this information in customer profile database 116. In some embodiments, service provider 114 may charge a fee to caller 102 for registering and using the service, in other embodiments, no fee is charged.

Subscriber 108 can register by contacting service provider 114 and informing service provider 114 that it would like to register with service provider 114 and communicate with callers using multiple forms of communication. Service provider 114 receives information from subscriber 108 and sends information to subscriber 108 that facilitates use of the service. In some embodiments, this includes receiving profile information about subscriber 108. This registration process can also include the addition or modification of software and/or hardware to subscriber 108's existing IVR system.

Subscriber 108 can be comprised of different forms of computer resources. For example, subscriber 108 can reside on a computer and use portions of the computer, service provider can also be a computer or more than one computer in communication with one another. In terms of entities, subscriber 108, can be a single user, a business, a government entity, or any other entity that receives services from service provider 114.

Once the registration procedure has been conducted, caller 102 and subscriber 108 are able to conduct multiple forms of communication with one another with the participation of service provider 114. Thus, the present invention takes advantage of widespread Internet availability (often with ADSL access) to improve the customer service that subscriber 108 provides. The following description describes one embodiment of a method in accordance with the present invention.

As an example, consider the case where subscriber 108 is a business and caller 102 is an individual. In step 204, caller 102 calls subscriber 108. In this case, caller 102 is a customer of subscriber 108 and caller 102 is calling to request assistance from subscriber 108. Caller 102 uses telephone 104 to call subscriber 108, and the call is routed through a first communications network 130. In this embodiment, first communications network 130 is a public switched telephone network (PSTN). The call is received by an Interactive Voice Response (IVR) system 112 associated with subscriber 108. IVR system 112 is configured to receive telephone calls from first network 130 and to manage those incoming calls.

Some customers find IVRs inconvenient and would rather receive information or assistance in a different way. To provide alternative and/or supplemental information and assistance to customers, different forms of communication can be used. In the current example, a system determines, in step 206, if the customer has registered to receive content. Additional details regarding step 206 are disclosed below. If it is determined that the customer has not registered to receive additional content, then the IVR session continues. This occurs in step 208.

If it is determined that the caller has registered to receive additional content, then additional information can be sent to computer 106 associated with caller 102. In some embodiments, subscriber 108 can provide an additional step to ask caller 102 to indicate if they would like to receive this additional content. Some embodiments omit this step and send additional content without an indication from caller 102. Preferably, the information sent to computer 106 includes information related to subscriber 108. In other embodiments, information related to a web site associated with subscriber 108 is sent to computer 106. One example of information sent to computer 106 is a Uniform Resource Locator (URL) associated with the company.

The preferred method for delivering the information to computer 106 is by having service provider 114 send the information to computer 106. To implement this method of delivery, subscriber 108 sends the information to service provider 114 and service provider 114, because it knows how to contact computer 106, can send the appropriate information received from subscriber 108 to computer 106, which is associated with customer 102. Preferably, a connection agent 120 associated with service provider 114 is used to receive communications from subscriber 108.

In this way, information related to caller 102 is not given to subscriber 108. Particularly, information regarding computer 106 is not provided to subscriber 108. This protects the caller's 102 personal information.

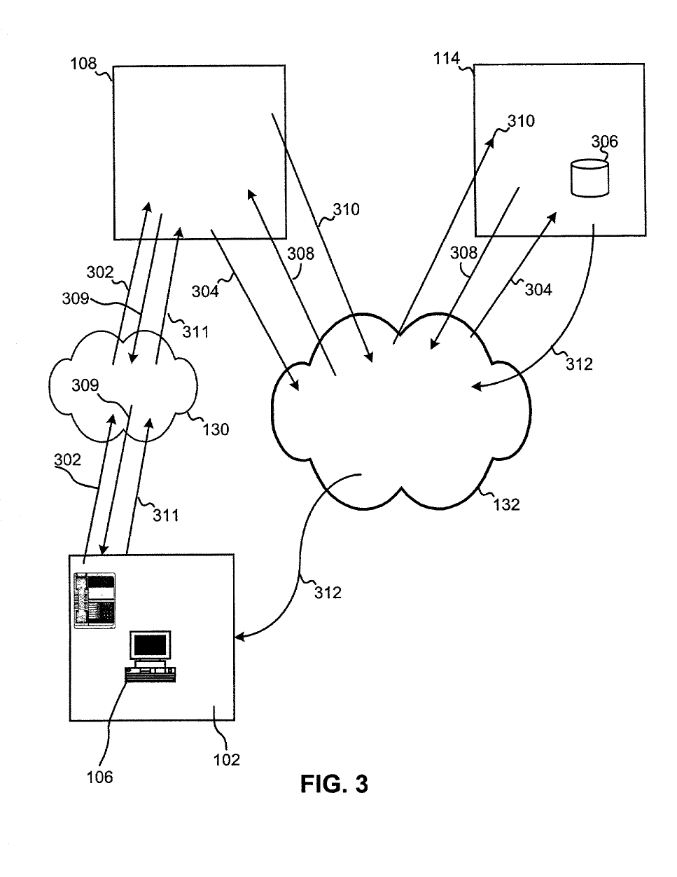

FIG. 3 is a schematic diagram showing detailed transactions between subscriber 108 and service provider 114. The process begins by a call 302 being placed by customer 102 to subscriber 108. After call 302 is received by subscriber 108, subscriber 108 sends a message 304 to service provider 114. Preferably, message 304 is sent through a data network 132, for example, the Internet. Message 304 can be sent using any desired or suitable message format and/or protocol. In some embodiments, Internet Protocol (IP) is used and message 304 is formatted in a proprietary format.

Generally, message 304 includes information related to subscriber 108 and information related to caller 102. In some embodiments, message 304 includes the profile information of subscriber 108 and the telephone number of caller 102. Message 304 can also include passwords, keys or other security devices that can be used to authenticate the message 304 and confirm the identity of the party sending message 304.

After receiving message 304, service provider 114 uses information contained in message 304 to determine whether caller 102 has registered and agreed to receive content. In some embodiments, the caller's 102 telephone number is used to determine whether caller 102 has registered to receive content. In some embodiments, service provider 114 searches database 306 that contains records related to callers that have registered to receive content.

Once service provider 114 has determined whether caller 102 has registered to receive content, service provider 114 sends a return message 308 back to subscriber 108. Preferably message 308 is sent through data network 132. Preferably, message 308 includes information that indicates whether caller 102 has registered to receive content. If caller 102 has not registered to receive content, then subscriber 108 proceeds with the current form of communication, in some embodiments, the IVR session is continued. However, if message 308 includes an indication that caller 102 has registered to receive content, then subscriber 108 knows it can communicate with caller 102 using a different form of communication.

Optionally, subscriber 108 can ask caller 102, in message 309, if caller 102 would like to receive additional information. In some cases, subscriber 108 prompts caller 102 through an IVR system. Subscriber 108 can send various items of information to caller 102. In some cases, subscriber 108 may offer a URL associated with a web site that provides helpful information, in other cases, subscriber 108 may offer documentation or an instruction manual that would be helpful to caller 102. Anything that might be helpful to caller 102 that can be delivered electronically can be offered by subscriber 108 and eventually sent to caller 102. After listening to the available options, caller 102 can respond with message 311, indicating desired information. In other embodiments, subscriber 108 does not request or prompt caller 102 for permission to send information, and just sends the information automatically.

Once subscriber 108 has determined that information needs to be sent to caller 102, subscriber 108 sends a message 310 to service provider 114. Message 310 includes information related to subscriber 108. In some cases, message 310 includes information related to a web site associated with subscriber 108. One example of information sent to computer 106 is a Uniform Resource Locator (URL) associated with the company. Another example could be specific information to be “pushed” to the subscriber, such as a video clip, a .wav file, or text information.

Information related to the information contained in message 310 is then sent to caller 102 in message 312. Message 312 is preferably sent through data network 132 and message 312 is configured in a way that permits computer 106 associated with caller 102 to use the information contained in message 312. Preferably, message 312 includes information that permits computer 106 to access information related to subscriber 108. In one example, message 312 includes URL information related to subscriber 108. Another example could be content provided by the subscriber, as discussed above. After receiving message 312, caller 102 can interact with resources and content associated with subscriber 108. Generally, this interaction occurs using a web site related to subscriber 108.

This interaction can be used in many ways to assist customers. In some cases, a subscriber 108 may place information helpful to customers including customer service information, manuals, directories, and other information. In this way, by applying principles of the present invention, subscribers and callers are able to communicate with one another using multiple forms of communication.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A communications system comprising:
a service provider capable of receiving registration information from a subscriber and a caller;
the service provider configured to receive a first message from the subscriber;
the first message including information related to the caller;
the service provider searching a database in response to the first message and sending a second message back to the subscriber;
the second message containing information related to the caller;
the service provider configured to receive a third message from the subscriber;
the third message including information related to the subscriber; and
wherein the service provider sends a fourth message to the caller in response to the third message.

2. The communications system according to claim 1, wherein the second message includes information related to the caller's registration information.

3. The communications system according to claim 1, wherein the fourth message includes information related to a web site associated with the subscriber.

4. The communications system according to claim 1, wherein the service provider is configured to receive the third message from an IVR associated with the subscriber.

5. The communications system according to claim 1, wherein the first message includes a phone number of the caller.

6. A service provider comprising:
means for receiving registration information from a subscriber;
means for receiving registration information from a caller;
means for receive a first message from the subscriber;
means for searching a database in response to the first message;
means for sending a second message back to the subscriber;
means for receiving a third message from the subscriber; and
means for sending a fourth message to the caller in response to the third message.

7. The service provider according to claim 6, wherein the second message includes information related to the caller's registration information.

8. The service provider according to claim 6, wherein the fourth message includes one of information related to a web site associated with the subscriber and content to be delivered to the caller.

9. The service provider according to claim 6, comprising means for receiving the third message from an IVR associated with the subscriber.

10. The service provider according to claim 6, comprising at least one of means for sending a proprietary message to a subscriber and means for receiving a proprietary message from a subscriber.

11. A method for conducting multiple communications comprising the steps of:
registering with a service provider;
receiving a call from a caller using a first form of communication;
sending a first item of information related to the caller to a service provider;
receiving, from the service provider, a second item of information related to the caller, the second item of information including information regarding the caller's registration for a service; and
sending a third item of information to the service provider, the third item of information including information related to a subscriber.

12. The method according to claim 11, wherein the first form of communication is a telephone call.

13. The method according to claim 11, wherein an IVR receives the call from the caller.

14. The method according to claim 11, wherein an IVR sends the first item of information to the service provider.

15. The method according to claim 11, wherein the first item of information includes the caller's telephone number.

16. The method according to claim 11, wherein the second item of information includes the caller's telephone number.

17. The method according to claim 11, wherein the third item of information includes a URL associated with the subscriber.
